(19) United States
(12) Patent Application Publication
(10) Pub. No.: US 2025/0104001 A1
(43) Pub. Date: Mar. 27, 2025

(54) HAZARDOUS-GOODS VEHICLE TRANSPORTATION SAFETY MONITORING CLIENT BASED ON CLOUD PLATFORM

(71) Applicant: THE THIRD RESEARCH INSTITUTE OF MINISTRY OF PUBLIC SECURITY, Shanghai (CN)

(72) Inventor: Caixia Liu, Shanghai (CN)

(21) Appl. No.: 18/730,522

(22) PCT Filed: Nov. 4, 2022
(86) PCT No.: PCT/CN2022/129887

§ 371 Date: Jul. 19, 2024

(30) Foreign Application Priority Data
Jun. 7, 2022 (CN) 202210656840.8

(51) Int. Cl. G06Q 10/0832; G08B 19/00

(52) U.S. Cl. CPC G06Q 10/0832; G08B 19/00

(57) ABSTRACT

The present invention discloses a cloud platform-based safety monitoring client for vehicle transportation of hazardous goods. The cloud platform-based safety monitoring client for vehicle transportation of hazardous goods is deployed in a manner supporting synchronous multi-level linkage of a plurality of user roles, and is configured to receive real-time information sent by an on-board terminal of a hazardous goods transportation vehicle, and perform synchronous multi-level linkage display on the received information and/or perform synchronous multi-level linkage processing based on the received information, to form corresponding feedback information for the on-board terminal of the hazardous goods transportation vehicle. The present invention is based on the cloud platform technology, which effectively achieves government industry management of vehicle transportation of hazardous goods across administrative regions and synchronous safety monitoring of vehicle information and information about on-board goods by an industry administration department, an enterprise operation management, and a driver and a passenger.

### CROSS-REFERENCE TO RELATED APPLICATIONS

The present application is a National Stage application of PCT international application: PCT/CN2022/129887, filed on 4 Nov. 2022, the disclosure of which is hereby incorporated by reference in its entirety.

### TECHNICAL FIELD

The present invention relates to safety monitoring technologies for transportation vehicles, and in particular, to a remote monitoring and transportation safety management technology for hazardous goods transportation vehicles.

### BACKGROUND

Transportation vehicles carrying hazardous goods are a significant moving source of danger, and are more prone to accidents compared to ordinary vehicles. Moreover, safety accidents in transportation of hazardous goods are different from common transportation accidents, which are more abrupt, complex, and harmful, and even lead to serious consequences such as combustion, explosion, and leakage, resulting in a series of social problems such as economic losses, environmental pollution, ecological damage, and casualties.

It may be learned from the above that performing comprehensive safety monitoring on vehicles carrying hazardous goods and on-board hazardous goods and ensuring safety of the transportation vehicles carrying hazardous goods are vital.

The related art provides a safety monitoring solution for on-board hazardous goods, vehicles carrying hazardous goods, and drivers. However, the existing monitoring solution has a plurality of limitations. First, the existing solution provides only simple monitoring on the on-board hazardous goods, the vehicles carrying hazardous goods, and the drivers. For example, only simple physical monitoring is performed for the on-board hazardous goods, or even no physical monitoring is provided. For the vehicles carrying hazardous goods, only positioning data of the vehicles may be monitored. For the drivers, only a continuous driving time of the drivers may be monitored. These limitations are significant. Furthermore, most existing solutions only store the monitoring data locally, and some data is uploaded to the traffic industry monitoring center for subsequent administrative management, which cannot achieve remote real-time safety control of vehicles and/or drivers.

Furthermore, the management of hazardous chemicals in China is performed by a plurality of departments such as public security, traffic, emergency, quality inspection, environmental protection, railways, and customs. Long-term problems such as insufficient application of monitoring technologies in various stages of hazardous goods transportation and poor information sharing exists, which lead to difficulties in information exchange in the safety management of hazardous goods vehicle transportation and information sharing among various industry administration departments involved in the safety management of hazardous goods vehicle transportation across administrative regions, and even bring serious adverse effects to rescue work of safety accidents during the hazardous goods transportation.

Therefore, how to perform comprehensive and real-time safety control on a vehicle (a transportation vehicle carrying hazardous goods), a person (a driver and/or an escort), and an object (hazardous goods) for the on-board hazardous goods during hazardous chemical vehicle transportation, break down industry barriers for hazardous chemical vehicle transportation, facilitate synchronous information exchange between a hazardous chemical transportation vehicle and an affiliated enterprise and the various industry administration departments during transportation, and ensure the safety of hazardous goods vehicle transportation is a problem urgently to be resolved in the art.

### SUMMARY

In view of a problem in an existing solution that comprehensive real-time remote multi-level and multi-industry control of a vehicle (such as a transportation vehicle carrying hazardous goods), a person (such as a driver and/or an escort), and an object (such as hazardous goods) during transportation of on-board hazardous goods cannot be remotely realized, a remote safety monitoring solution for vehicle transportation of hazardous goods is required.

The present invention is intended to provide a cloud platform-based safety monitoring client for vehicle transportation of hazardous goods. The solution is based on a cloud computing technology. Real-time monitoring information of a hazardous goods transportation vehicle driver, a vehicle, and on-board goods, including physical and chemical safety monitoring information of on-board hazardous goods and anti-theft and anti-robbery monitoring information is synchronously uploaded to an industry administration department and an affiliated enterprise in real time, which effectively achieves industry management of vehicle transportation of hazardous goods across administrative regions and synchronous safety monitoring of vehicle information and information about on-board goods by an industry administration department, an enterprise operation management, and a driver and a passenger, thereby effectively improving the efficiency of emergency response to hazardous goods transportation safety accidents and an anti-terrorism prevention ability for hazardous goods transportation.

In order to achieve the above purpose, the cloud platform-based safety monitoring client for vehicle transportation of hazardous goods provided in the present invention is deployed in a manner supporting synchronous multi-level linkage of a plurality of user roles, and is configured to receive real-time information sent by an on-board terminal of a hazardous goods transportation vehicle, and perform synchronous multi-level linkage display on the received information and/or perform synchronous multi-level linkage processing based on the received information, to form corresponding feedback information for the on-board terminal of the hazardous goods transportation vehicle.

Further, the feedback information includes one or more of system configuration information, emergency response information, safety warning information, and control command information.

Further, the safety monitoring client for vehicle transportation of hazardous goods includes:
a government industry management client unit, an enterprise operation management client unit, a driver and passenger service client unit, and a communication center.

The government industry management client unit is configured to: receive and display real-time monitoring information and/or danger warning alarm information for hazardous goods and/or a vehicle carrying hazardous goods and/or a vehicle driver sent by the on-board terminal of the hazardous goods transportation vehicle, send a relevant management command based on the received warning alarm information, start an emergency management process, and issue a relevant emergency response command.

The enterprise operation management client unit is configured to: receive and display the real-time monitoring information and/or the danger warning alarm information for the hazardous goods and/or the vehicle carrying hazardous goods and/or the vehicle driver sent by the on-board terminal of the hazardous goods transportation vehicle, send a relevant management command based on the received warning alarm information, start an emergency management process, and issue a relevant emergency response command; and start the emergency management process, issue the relevant emergency response command, and issue an emergency alarm and the relevant emergency response command to the government industry management client unit when receiving high-risk-level danger warning alarm information.

The driver and passenger service client unit is configured to: receive and display the real-time monitoring information and/or the danger warning alarm information for the hazardous goods and/or the vehicle carrying hazardous goods and/or the vehicle driver sent by the on-board terminal of the hazardous goods transportation vehicle, and generate a corresponding alarm prompt and/or emergency response guidelines corresponding to the warning alarm information based on the received danger warning alarm information.

The communication center is configured to: store the real-time monitoring information and/or the danger warning alarm information for the hazardous goods and/or the vehicle carrying hazardous goods and/or the vehicle driver sent by the on-board terminal of the hazardous goods transportation vehicle, and forward the received information and/or an analysis result to the government industry management client unit, the enterprise operation management client unit, and the driver and passenger service client unit, where the communication center is further configured as a computer system environment for the government industry management client unit, the enterprise operation management client unit, and the driver and passenger service client unit, supports a relevant software application, and forwards a management command or a response command of the government industry management client unit, the enterprise operation management client unit, and the driver and passenger service client unit to the on-board terminal of the hazardous goods transportation vehicle.

Further, the government industry management client unit includes a public security industry management client software, a traffic industry management client software, an emergency industry management client software, and another industry management client software depending on different industry administration departments.

The public security industry management client software is configured to: receive the real-time monitoring information and/or the danger warning alarm information for the hazardous goods and/or the vehicle carrying hazardous goods and/or the vehicle driver sent by the on-board terminal of the hazardous goods transportation vehicle forwarded by the communication center, send a traffic management command to a traffic policeman on duty at a position of the vehicle and send a traffic accident handling command for the corresponding vehicle and position to a relevant traffic accident handling person based on a type of the information, and send emergency rescue linkage management information according to a set emergency plan; and send warning information to the enterprise operation management client unit and the driver and passenger service client unit, and send linkage management information according to the set emergency plan.

The traffic industry management client software is configured to: receive the real-time monitoring information and/or the danger warning alarm information for the hazardous goods and/or the vehicle carrying hazardous goods and/or the vehicle driver sent by the on-board terminal of the hazardous goods transportation vehicle forwarded by the communication center, send a management command to a relevant traffic safety accountability enterprise based on the type of the information, and send other linkage management information according to the set emergency plans; and send warning information to the enterprise operation management client unit and the driver and passenger service client unit, and send linkage management information according to the set emergency plan.

The emergency industry management client software is configured to: receive and display the real-time monitoring information and/or the danger warning alarm information for the hazardous goods and/or the vehicle carrying hazardous goods and/or the vehicle driver sent by the on-board terminal of the hazardous goods transportation vehicle forwarded by the communication center, send an emergency response command to a relevant emergency rescue person based on the type of the information, a type of the vehicle, a type of the goods loaded on the vehicle, and behavior state information of the driver, and send other linkage management information according to the set emergency plan.

The another industry management client software is configured to: receive and display the real-time monitoring information and/or the danger warning alarm information for the hazardous goods and/or the vehicle carrying hazardous goods and/or the vehicle driver sent by the on-board terminal of the hazardous goods transportation vehicle forwarded by the communication center, start an insurance claims service based on a state of the information, and send other linkage management information according to the set emergency plan.

Further, the public security industry management client software is configured for driver identity verification management, driver identity management, abnormal driver behavior and fatigue state monitoring and alarm, vehicle safety monitoring and alarm, and on-board hazardous goods safety monitoring and alarm.

Further, the traffic industry management client software is configured for driver identity verification management, driver permission supervision, abnormal driver behavior and fatigue state monitoring and alarm, driver and passenger archive management, driver behavior evaluation, vehicle safety monitoring and alarm, and on-board hazardous goods safety monitoring and alarm.

Further, the emergency industry management client software is further configured for driver identity verification management, abnormal driver behavior and fatigue state monitoring and alarm, vehicle safety monitoring and alarm, and on-board hazardous goods safety monitoring and alarm.

Further, the enterprise operation management client unit includes a consigner management client software, a carrier management client software, and a receiver management client software depending on different users.

The consigner management client software is configured to receive and display the safety tracking and querying information of the goods consignment vehicle, query the electronic waybill of the hazardous goods, and query the driver identity information.

The carrier management client software is configured to: receive and display the real-time monitoring information and/or the danger warning alarm information for the hazardous goods and/or the vehicle carrying hazardous goods and/or the vehicle driver sent by the on-board terminal of the hazardous goods transportation vehicle forwarded by the communication center; send emergency rescue guide information and/or warning information to the driver and passenger service client unit when receiving the warning alarm information; and send the emergency rescue guide information and/or warning information to the driver and passenger service client unit, and immediately synchronously send linkage alarm information to the government industry management client unit according to the set emergency plan when receiving a high-risk-level warning alarm.

The receiver management client software is configured to receive and display the safety tracking and querying information of the goods consignment vehicle, query the electronic waybill of the hazardous goods, and query the driver identity information.

Further, the carrier management client software is configured for driver identity verification management, abnormal driver behavior and fatigue state monitoring, driver overtime driving alarm management, driver and passenger archive management, driver behavior evaluation, vehicle safety monitoring and alarm, and on-board hazardous goods safety monitoring and alarm, where the driver identity verification management of the carrier management client software supports remote driver permission authorization and remote emergency enable of a vehicle ACC switch, and supports recording, analysis, and querying of received driver and passenger identity verification results, driver and passenger identity information, and results of comparison between and analysis of the driver and passenger identity information and affiliated enterprise driver and passenger archive information or electronic waybill scheduling information.

Further, the driver and passenger service management client unit includes a driver service client software, an escort service client software, and a stevedore service client software depending on different users.

The driver service client software is configured to: receive and display the real-time monitoring information and/or the danger warning alarm information for the hazardous goods and/or the vehicle carrying hazardous goods and/or the vehicle driver sent by the on-board terminal of the hazardous goods transportation vehicle forwarded by the communication center, and receive and display emergency rescue guide information sent by the enterprise operation management client unit or display emergency rescue guide information or a driving-permitted command automatically pushed after relevant warning alarm information is triggered; and support feedback of a risk detection status and a handling result to the government industry management client unit and the enterprise operation management client unit after the driver completes a risk detection.

The escort service client software is configured to: receive and display the real-time monitoring information and/or the danger warning alarm information for the hazardous goods and/or the vehicle carrying hazardous goods and/or the vehicle driver sent by the on-board terminal of the hazardous goods transportation vehicle forwarded by the communication center; receive and display emergency rescue guide information sent by the enterprise operation management client unit or display emergency rescue guide information or a driving-permitted command automatically pushed after relevant warning alarm information is triggered; and generate corresponding warning information after receiving a risk alarm sent by the government industry management client unit and the enterprise operation management client unit; and supports an escort to feed back a risk detection status and a handling result to the government industry management client and the carrier management client after the driver completes a risk detection.

The stevedore service client software is configured to receive and display an electronic waybill of road transportation of the hazardous goods, and a quantity change and inventory information of the hazardous goods during loading/unloading, and supports querying of a type, a quantity, a loading/unloading requirement, a physical characteristic, a chemical characteristic, a physical and chemical hazard, and corresponding emergency rescue guide information of the hazardous goods currently being transported.

Further, the driver service client software is configured for driver identity verification management, abnormal driver behavior and fatigue state monitoring, driver overtime driving alarm management, vehicle safety monitoring and alarm, and on-board hazardous goods safety monitoring and alarm; and the escort service client software is configured for driver identity verification management, escort identity verification management, abnormal driver behavior and fatigue state monitoring, driver overtime driving alarm management, vehicle safety monitoring and alarm, and on-board hazardous goods safety monitoring and alarm.

Further, the communication center includes a cloud platform and a personal mobile intelligent terminal.

The cloud platform is configured for storage of data information and alarm information uploaded by the on-board terminal of the hazardous goods transportation vehicle, receipt of data of the government industry management client software/the enterprise operation management client software/the driver and passenger service client software, and communication interaction among a called shared data resource pool, a computer hardware platform environment supporting application of the government industry management client software/the enterprise operation management client software/the driver and passenger service client software, the government industry management client software/the enterprise operation management client software/the driver and passenger service client software, and an on-board gateway unit.

The personal mobile intelligent terminal is configured for storage of data information and alarm information uploaded by the on-board terminal of the hazardous goods transportation vehicle and communication interaction among an online querying tool and a temporary storage space of the uploaded data information for the government industry management client APP software/the enterprise operation management client APP software/the driver and passenger service client APP software, a microcomputer hardware platform environment supporting application of the government industry management client APP software/the enterprise operation management client APP software/the driver and passenger service client APP software, the government industry management client APP software/the enterprise operation management client APP software/the driver and passenger service client APP software, and the on-board gateway unit.

According to the cloud platform-based safety monitoring client for vehicle transportation of hazardous goods provided in the present invention, based on the cloud technology, for transportation of hazardous goods, government industry management across administrative regions is effectively achieved, so that real-time linkage of physical and chemical safety monitoring information of on-board hazardous goods and anti-theft and anti-robbery monitoring information to the industry administration department and the affiliated enterprise can be achieved, thereby effectively improving the efficiency of emergency response to hazardous goods transportation safety accidents and an anti-terrorism prevention ability for hazardous goods transportation.

### BRIEF DESCRIPTION OF THE DRAWINGS

The present invention is further described below with reference to drawings and specific implementations.

FIG. 1 is a schematic diagram of a composition principle of a cloud platform-based safety monitoring client for vehicle transportation of hazardous goods according to an embodiment of the present invention.

FIG. 2 is a schematic diagram of a composition principle of a government industry management client unit according to an embodiment of the present invention.

FIG. 3 is a schematic diagram of a composition principle of an enterprise operation management client unit according to an embodiment of the present invention.

FIG. 4 is a schematic diagram of a composition principle of a driver and passenger service client unit according to an embodiment of the present invention.

FIG. 5 is a schematic composition diagram of a communication center according to an embodiment of the present invention.

### DETAILED DESCRIPTION

In order to make technical means, creative features, purposes, and efficacy of the present invention easy to understand, the present invention is further elaborated below with reference to the drawings.

In view of a problem in an existing safety monitoring solution for vehicle transportation of hazardous goods that comprehensive remote multi-level control of a vehicle (such as a transportation vehicle carrying hazardous goods), a person (such as a driver and/or an escort), and an object (such as hazardous goods) during transportation of on-board hazardous goods cannot be remotely realized, the embodiments provide a solution of a cloud platform-based safety monitoring client for vehicle transportation of hazardous goods based on a cloud computing technology. In the solution, real-time monitoring information of a hazardous goods transportation vehicle driver, a vehicle, and on-board goods, including physical and chemical safety monitoring information of on-board hazardous goods and anti-theft and anti-robbery monitoring information is synchronously uploaded to a vehicle industry administration department and an affiliated enterprise in real time, which effectively achieves government industry management of vehicle transportation of hazardous goods across administrative regions and synchronous safety monitoring of vehicle information and information about the on-board goods by an industry administration department, an enterprise operation management, and a driver and a passenger, thereby effectively improving the efficiency of emergency response to hazardous goods transportation safety accidents and an anti-terrorism prevention ability for hazardous goods transportation.

The cloud platform-based safety monitoring client for vehicle transportation of hazardous goods is arranged on a cloud platform of a vehicle transportation-related government industry administration department and/or a local storage server and/or a personal mobile intelligent terminal of a relevant management person, a cloud platform of a transportation enterprise to which a vehicle belongs and a related transportation party and/or a personal mobile intelligent terminal of a relevant management person, and a personal mobile intelligent terminal of a driver and a passenger, and performs information data association with an on-board terminal of a hazardous goods transportation vehicle on a front-end vehicle.

The safety monitoring client for vehicle transportation of hazardous goods is deployed in a manner supporting synchronous multi-level linkage of a plurality of user roles, and is configured to receive real-time information sent by an on-board terminal of a hazardous goods transportation vehicle, and perform synchronous multi-level linkage display on the received information and/or perform synchronous multi-level linkage processing based on the received information, to form corresponding feedback information for the on-board terminal of the hazardous goods transportation vehicle.

The cloud platform-based safety monitoring client for vehicle transportation of hazardous goods may send a command to the on-board terminal of the hazardous goods transportation vehicle to adjust an alarm threshold of a relevant sensor or send emergency rescue guide information to a hazardous goods transportation emergency rescue guide unit to provide guidance through a voice or a video file, and receive physical and chemical safety monitoring information of on-board hazardous goods and anti-theft and anti-robbery monitoring and warning information of on-board hazardous goods sent by the on-board terminal of the hazardous goods transportation vehicle.

The cloud platform-based safety monitoring client for vehicle transportation of hazardous goods may receive a driver identity verification result and a driver state monitoring result sent by the on-board terminal of the hazardous goods transportation vehicle and provide a vehicle management and driver management control command, or receive a driver identity information acquisition result and a driver state monitoring information acquisition result sent by the on-board terminal of the hazardous goods transportation vehicle; identify driver identity information or compare the identity information with biometric information or identify relevant identity information and biometric information and compare same with official archive database information and affiliated enterprise archive information; perform identification, analysis, and determination based on a real-time sentiment and/or an abnormal driving behavior and/or a fatigue state of a driver; and determine a vehicle management and driver management control command based on a sentiment identification result and/or an abnormal behavior analysis and/or a fatigue state determination result, and feed back the vehicle management and driver management control command to the on-board terminal of the hazardous goods transportation vehicle for receipt, so as to send an acousto-optic alarm or a voice prompt or control a vehicle ACC to enable or disable or control the vehicle to perform speed limit, deceleration, or emergency braking.

The cloud platform-based safety monitoring client for vehicle transportation of hazardous goods may receive monitoring data and risk alarm information sent by the on-board terminal of the hazardous goods transportation vehicle, and send emergency response information and emergency rescue management information based on a requirement of the emergency plan when receiving a high-risk-level alarm.

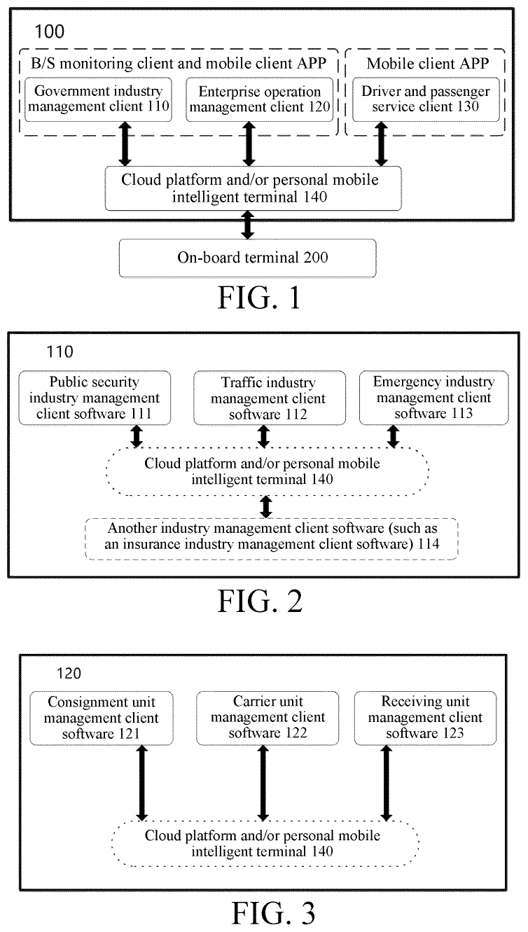

FIG. 1 is a schematic diagram of a composition principle and a use process of a cloud platform-based safety monitoring client for vehicle transportation of hazardous goods according to an embodiment.

As shown in FIG. 1, a cloud platform-based safety monitoring client 100 for vehicle transportation of hazardous goods provided in this embodiment is composed of a government industry management client unit 110, an enterprise operation management client unit 120, a driver and passenger service client unit 130, and a communication center (which is a cloud platform and/or a personal mobile intelligent terminal) 140 in cooperation with each other.

The government industry management client unit 110 is configured to receive and display safety monitoring information of on-board hazardous goods sent by an on-board terminal 200 of a hazardous goods transportation vehicle, such as high-risk-level physical and chemical safety monitoring and warning information of the on-board hazardous goods or high-risk-level anti-theft and anti-robbery monitoring and warning information of the on-board hazardous goods, send a relevant management command based on the received warning alarm information, start an emergency management process, and issue a relevant emergency response command.

The government industry management client unit 110 is further configured to receive and display vehicle safety monitoring information sent by the on-board terminal 200 of the hazardous goods transportation vehicle, such as high-risk-level real-time monitoring and warning information of tire pressure, high-risk-level vehicle overheat monitoring and warning information, and high-risk-level warning information of new energy vehicle lithium-ion power battery explosion, send a relevant management command based on the received warning alarm information, start an emergency management process, and issue a relevant emergency response command.

The government industry management client unit 110 may further receive and display a driver identity document acquisition result, a driver biometric information acquisition result, and an identity verification result sent by the on-board terminal 200 of the hazardous goods transportation vehicle, perform supplementary content identity verification based on a driver identity document acquisition result and the driver biometric information acquisition result, receive and display a driver state monitoring result sent by the on-board terminal 200 of the hazardous goods transportation vehicle, send a relevant management command and manage the driver based on the received driver state monitoring result, and start an emergency management process and issue a relevant emergency response command when the received driver state monitoring result shows a significant abnormality.

The enterprise operation management client unit 120 is configured to: receive and display safety monitoring information of on-board hazardous goods sent by the on-board terminal 200 of the hazardous goods transportation vehicle for the hazardous goods, such as physical and chemical safety monitoring and warning information of the on-board hazardous goods or anti-theft and anti-robbery monitoring and warning information of the on-board hazardous goods; send a relevant management command or emergency rescue guide information based on the received warning alarm information; and start an emergency management process, push emergency rescue guide file information for the on-board hazardous goods to the on-board terminal 200 of the hazardous goods transportation vehicle, send an emergency alarm to the government industry management client, and issue a relevant emergency response command when receiving high-risk-level physical and chemical safety monitoring and warning information of the on-board hazardous goods or high-risk-level anti-theft and anti-robbery monitoring and warning information of the on-board hazardous goods.

The enterprise operation management client unit 120 is further configured to receive and display vehicle safety monitoring information sent by the on-board terminal 200 of the hazardous goods transportation vehicle for a vehicle carrying hazardous goods, such as real-time monitoring and warning information of tire pressure, vehicle overheat monitoring and warning information, and warning information of new energy vehicle lithium-ion power battery explosion, and send a relevant management command based on the received warning alarm information. The enterprise operation management client unit 120 starts the emergency management process, sends the emergency alarm to the government industry management client, and issues the relevant emergency response command when receiving high-risk-level real-time monitoring and warning information of the tire pressure, high-risk-level vehicle overheat monitoring and warning information, and high-risk-level warning information of the new energy vehicle lithium-ion power battery explosion.

The enterprise operation management client unit 120 further receives and displays the driver identity document acquisition result, the driver biometric information acquisition result, and the identity verification result sent by the on-board terminal 200 of the hazardous goods transportation vehicle for the driver of the vehicle carrying hazardous goods, performs supplementary content identity verification based on a driver identity document acquisition result and the driver biometric information acquisition result, receives and displays a driver state monitoring result sent by the on-board terminal 200 of the hazardous goods transportation vehicle, sends a relevant management command and manage the driver based on the received driver state monitoring result, and starts an emergency management process, sends an emergency alarm to the government industry management client, and issues a relevant emergency response command when the received driver state monitoring result shows a significant abnormality.

The driver and passenger service client unit 130 is configured to receive and display safety monitoring information of the on-board hazardous goods sent by the on-board terminal 200 of the hazardous goods transportation vehicle for the on-board hazardous goods, such as physical and chemical safety monitoring and warning information or anti-theft and anti-robbery monitoring and warning information of the on-board hazardous goods, send an acousto-optic alarm, a voice prompt, and emergency rescue guide corresponding to the alarm warning information based on the received alarm warning information, prompt the driver stop nearby or immediately stop for inspection, and provide corresponding emergency response guidelines.

The driver and passenger service client unit 130 is further configured to receive and display vehicle safety monitoring information sent by the on-board terminal 200 of the hazardous goods transportation vehicle for the vehicle carrying hazardous goods, such as real-time monitoring and warning information of tire pressure, vehicle overheat monitoring and warning information, and warning information of new energy vehicle lithium-ion power battery explosion, send an acousto-optic alarm, a voice prompt, and an emergency rescue guide corresponding to the alarm warning information based on the received alarm warning information, prompt the driver to stop nearby or immediately stop for inspection, and provide corresponding emergency response guidelines.

The driver and passenger service client unit 130 further receives and displays an identity verification result sent by the on-board terminal 200 of the hazardous goods transportation vehicle for the driver of the vehicle carrying hazardous goods, sends a vehicle start prompt or an attitude adjustment for re-verification prompt based on the driver identity verification result, receives and displays a driver state monitoring result sent by the on-board terminal 200 of the hazardous goods transportation vehicle, and sends a relevant alarm prompt based on the received driver state monitoring result.

The communication center 140 is further configured as a computer system environment for the government industry management client unit 110, the enterprise operation management client unit 120, and the driver and passenger service client unit 130, supports a relevant software application, and forwards a management command or a response command of the government industry management client unit, the enterprise operation management client unit, and the driver and passenger service client unit to the on-board terminal 200 of the hazardous goods transportation vehicle.

Specifically, the communication center 140 may communicate with the on-board terminal 200 of the hazardous goods transportation vehicle, receive and store the safety monitoring information of the on-board hazardous goods sent by the on-board terminal 200 of the hazardous goods transportation vehicle for the on-board hazardous goods, such as the physical and chemical safety monitoring and warning information of the on-board hazardous goods or the anti-theft and anti-robbery monitoring and warning information of the on-board hazardous goods, and forward the information to the government industry management client unit 110, the enterprise operation management client unit 120, and the driver and passenger service client unit 130.

The communication center 140 receives and stores the vehicle safety monitoring information sent by the on-board terminal 200 of the hazardous goods transportation vehicle for the vehicle carrying hazardous goods, such as the real-time monitoring and warning information of tire pressure, the vehicle overheat monitoring and warning information, and the warning information of new energy vehicle lithium-ion power battery explosion, and forwards the information to the government industry management client unit 110, the enterprise operation management client unit 120, and the driver and passenger service client unit 130.

The communication center 140 receives and stores the driver identity document acquisition result, the driver biometric information acquisition result, or the identity verification result sent by the on-board terminal 200 of the hazardous goods transportation vehicle for the driver of the vehicle carrying hazardous goods, and receives and stores current dynamic facial expression information of the driver, current head, face, and body movement attitude information of the driver, current head and face movement information of the driver, and pressure state information of a seat under the driver or the driver state monitoring result acquired by the on-board terminal 200 of the hazardous goods transportation vehicle. When a biometric information comparison component, an intelligent sentiment analysis and identification component, an abnormal behavior analysis and identification component, a video analysis-based fatigue state analysis component, or a sensor network analysis-based fatigue state analysis component is arranged on the safety monitoring client 100 for vehicle transportation of hazardous goods, biometric information comparison, intelligent sentiment analysis and identification, abnormal behavior analysis and identification, or fatigue state analysis and determination may be performed through a cloud platform of the communication center 140.

According to the cloud platform-based safety monitoring client 100 for vehicle transportation of hazardous goods, government industry management across administrative regions and industries is effectively achieved, so that real-time linkage of physical and chemical safety monitoring information of on-board hazardous goods and anti-theft and anti-robbery monitoring information to the industry administration department and the affiliated enterprise can be achieved, thereby effectively improving the efficiency of emergency response to hazardous goods transportation safety accidents and an anti-terrorism prevention ability for hazardous goods transportation.

Based on the above, an embodiment further clearly provides a specific device of a constituent module of each unit in the safety monitoring client for vehicle transportation of hazardous goods.

FIG. 2 is a schematic diagram of a composition principle of the government industry management client unit 110 in the safety monitoring client 100 for vehicle transportation of hazardous goods according to an embodiment.

As shown in FIG. 2, the government industry management client 110 in a remote management unit provided in this embodiment includes a public security industry management client software 111, a traffic industry management client software 112, an emergency industry management client software 113, and another industry management client software 114 (such as an insurance industry management client software) depending on different industry administration departments.

As shown in FIG. 2, the public security industry management client software 111 in the government industry management client 110 in this embodiment is configured to: receive the safety monitoring information of the on-board hazardous goods sent by the on-board terminal 200 of the hazardous goods transportation vehicle for the hazardous goods forwarded by the communication center 140, such as the high-risk-level physical and chemical safety monitoring and warning information of the on-board hazardous goods or the high-risk-level anti-theft and anti-robbery monitoring and warning information of the on-board hazardous goods, send a traffic management command to a traffic policeman on duty at a position of the vehicle and send a traffic accident handling command for the corresponding vehicle and position to a relevant traffic accident handling person based on a type of the information, and send other linkage management information such as emergency rescue according to a set emergency plan.

The public security industry management client software 111 is further configured to: receive and display the vehicle safety monitoring information sent by the on-board terminal 200 of the hazardous goods transportation vehicle for the carried hazardous goods forwarded by the communication center 140, such as the high-risk-level real-time monitoring and warning information of tire pressure, the high-risk-level vehicle overheat monitoring and warning information, and the high-risk-level warning information of new energy vehicle lithium-ion power battery explosion, send a traffic management command to a traffic policeman on duty at a position of the vehicle and send a traffic accident handling command for the corresponding vehicle and position to a relevant traffic accident handling person based on a type of the information, and send other linkage management information such as emergency rescue 120 according to a set emergency plan.

The public security industry management client software 111 is further configured for driver identity verification management, driver identity management, and abnormal driver behavior and fatigue state monitoring and alarm.

Through the driver identity verification management, a driver and passenger identity verification result may be received, and recording and querying may be performed. Through the driver identity management, the driver identity information and the identity verification result may be received, and may be compared and analyzed with motor vehicle driving license archive information of the public security organization. When the driver identity information, an authorized vehicle type, or the like is inconsistent with the driving license archive information, or an authorized vehicle type in a personal motor vehicle driving license corresponding to the driver identity information does not include B2, an alarm is sent. Warning information in a form of a text, an image, a voice, a file, or the like is sent to the enterprise operation management client unit and a driver service client unit during alarm, and linkage management information is sent according to the set emergency plan. Through the abnormal driver behavior and fatigue state monitoring and alarm, monitoring and alarm information of an abnormal sentiment, an abnormal behavior, and a fatigue state of the driver may be received and displayed. When a high-risk alarm is received, warning information is sent to the enterprise operation management client unit and the driver and passenger service client unit in the form of a text, an image, a voice, a file, or the like, and linkage management information is sent according to the set emergency plan.

The traffic industry management client software 112 in the government industry management client 110 in this embodiment is configured to: receive the safety monitoring information of the on-board hazardous goods sent by the on-board terminal 200 of the hazardous goods transportation vehicle for the hazardous goods forwarded by the communication center 140, such as the physical and chemical safety monitoring and warning information of the on-board hazardous goods or the anti-theft and anti-robbery monitoring and warning information of the on-board hazardous goods, send a management command to a relevant traffic safety accountability enterprise based on the type of the information, and send other linkage management information according to the set emergency plan.

The traffic industry management client software 112 is further configured to: receive and display the vehicle safety monitoring information sent by the on-board terminal 200 of the hazardous goods transportation vehicle for the vehicle carrying hazardous goods forwarded by the communication center 140, such as the high-risk-level real-time monitoring and warning information of tire pressure, the high-risk-level vehicle overheat monitoring and warning information, and the high-risk-level warning information of new energy vehicle lithium-ion power battery explosion, send a management command to the relevant traffic safety accountability enterprise based on the type of the information, and send other linkage management information according to the set emergency plan.

The traffic industry management client software 112 is further configured for driver identity verification management, driver permission supervision, abnormal driver behavior and fatigue state monitoring and alarm, driver and passenger archive management, and driver behavior evaluation.

Through the driver identity verification management, a driver identity verification result may be received, and recording and querying may be performed. Through the driver permission supervision, driver identity verification alarm information may be received and displayed, driver permissions for vehicle driving may be supervised, and emergency authorization of driver permissions may be provided. Through the abnormal driver behavior and fatigue state monitoring and alarm, monitoring and alarm information of an abnormal sentiment, an abnormal behavior, and a fatigue state of the driver may be received and displayed. When a high-risk alarm is received, warning information is sent to the enterprise operation management client and the driver and passenger service client in the form of a text, an image, a voice, a file, or the like, and linkage management information is sent according to the set emergency plan. Through the driver and passenger archive management, an archive of a driver and a passenger such as the driver or an escort of a hazardous chemical transportation vehicle may be managed. Content of the archive management includes a name, a gender, an ID number, a company name, a qualification certificate number, a qualification certificate validity, and a personnel category. The driver behavior evaluation supports driver behavior evaluation based on relevant information such as different alarm types, alarm numbers, and alarm levels.

The emergency industry management client software 113 in the government industry management client 110 in this embodiment is configured to: receive the safety monitoring information of the on-board hazardous goods sent by the on-board terminal 200 of the hazardous goods transportation vehicle for the on-board hazardous goods forwarded by the communication center 140, such as the high-risk-level physical and chemical safety monitoring and warning information of the on-board hazardous goods or the high-risk-level anti-theft and anti-robbery monitoring and warning information of the on-board hazardous goods, send an emergency response command to a relevant emergency rescue person such as a firefighter based on the type of the information, a type of the vehicle, a type of the goods carried by the vehicle, and the like, and send other linkage management information according to the set emergency plan.

The emergency industry management client software 113 is further configured to: receive and display the vehicle safety monitoring information sent by the on-board terminal 200 of the hazardous goods transportation vehicle for the vehicle carrying hazardous goods forwarded by the communication center 140, such as the high-risk-level real-time monitoring and warning information of tire pressure, the high-risk-level vehicle overheat monitoring and warning information, and the high-risk-level warning information of new energy vehicle lithium-ion power battery explosion, send an emergency response command to a relevant emergency rescue person such as a firefighter based on the type of the information, the type of the vehicle, the type of the goods carried by the vehicle, and the like, and send other linkage management information according to the set emergency plan.

The emergency industry management client software 113 is further configured for driver identity verification management and abnormal driver behavior and fatigue state monitoring and alarm.

Through the driver identity verification management, a driver and passenger identity verification result may be received, and recording and querying may be performed. Through the abnormal driver behavior and fatigue state monitoring and alarm, monitoring and alarm information of an abnormal sentiment, an abnormal behavior, and a fatigue state of the driver may be received and displayed. When a high-risk alarm is received, warning information is sent to the enterprise operation management client and the driver and passenger service client in the form of a text, an image, a voice, a file, or the like, and linkage management information is sent according to the set emergency plan.

The another industry management client software 114 (such as an insurance industry management client software 114) in the government industry management client 110 in this embodiment is configured to: receive the safety monitoring information of the on-board hazardous goods sent by the on-board terminal 200 of the hazardous goods transportation vehicle for the on-board hazardous goods forwarded by the communication center 140, such as the physical and chemical safety monitoring and warning information of the on-board hazardous goods or the anti-theft and anti-robbery monitoring and warning information of the on-board hazardous goods, start an insurance claims service based on a state of the information, and send other linkage management information according to the set emergency plan.

The another industry management client software 114 is further configured to: receive and display the vehicle safety monitoring information sent by the on-board terminal 200 of the hazardous goods transportation vehicle for the vehicle carrying hazardous goods forwarded by the communication center 140, such as the real-time monitoring and warning information of tire pressure, the vehicle overheat monitoring and warning information, and the warning information of new energy vehicle lithium-ion power battery explosion, start an insurance claims service based on a state of the information, and send other linkage management information according to the set emergency plan.

The another industry management client software 114 is further configured for driver identity verification management. Through the driver identity verification management, a driver and passenger identity verification result may be received, and recording and querying may be performed.

It should be noted that the another industry management client software further supports function customization based on a corresponding industry management demand or independent enable or disable of a relevant monitoring client function within a user permission range, which is not limited herein.

FIG. 3 is a schematic diagram of a composition principle of an enterprise operation management client 120 in the safety monitoring client for vehicle transportation of hazardous goods according to an embodiment.

As shown in FIG. 3, the enterprise operation management client 120 provided in this embodiment includes a consigner management client software 121, a carrier management client software 122, and a receiver management client software 123 depending on different users.

As shown in FIG. 1 and FIG. 2, the consigner management client software 121 in the enterprise operation management client 120 in this embodiment is configured to receive and display safety tracking and querying information of a goods consignment vehicle (that is, the vehicle carrying hazardous goods).

Further, the consigner management client software 121 is further configured for driver identity information querying. For example, the software supports querying of identity information, a qualification certificate, and a current transportation identity verification result of a current transportation driver or an escort of the hazardous goods transportation vehicle corresponding to an electronic waybill number.

The carrier management client software 122 in the enterprise operation management client 120 in this embodiment is configured to: receive the physical and chemical safety monitoring and warning information of the on-board hazardous goods or the anti-theft and anti-robbery monitoring and warning information of the on-board hazardous goods sent by the on-board terminal 200 of the hazardous goods transportation vehicle for the on-board hazardous goods forwarded by the communication center 140; send emergency rescue guide information to the driver and passenger service client unit 130 in the form of a text, an image, a voice, a file, or the like when receiving warning alarm information; and send emergency rescue guide information to the driver and passenger service client unit 130 in the form of a text, an image, a voice, a file, or the like and immediately synchronously send linkage alarm information to the government industry management client unit 110 according to the set emergency plan when receiving a high-risk-level warning alarm.

The carrier management client software 122 is further configured to: receive and display the vehicle safety monitoring information sent by the on-board terminal 200 of the hazardous goods transportation vehicle for the vehicle carrying hazardous goods forwarded by the communication center 140, such as the real-time monitoring and warning information of tire pressure, the vehicle overheat monitoring and warning information, and the warning information of new energy vehicle lithium-ion power battery explosion; send emergency rescue guide information to the driver and passenger service client unit 130 in the form of a text, an image, a voice, a file, or the like when receiving warning alarm information; and send emergency rescue guide information to the driver and passenger service client unit 130 in the form of a text, an image, a voice, a file, or the like and immediately synchronously send linkage alarm information to the government industry management client unit 110 according to the set emergency plan when receiving a high-risk-level warning alarm.

The carrier management client software 122 is further configured for driver identity verification management, abnormal driver behavior and fatigue state monitoring, driver overtime driving alarm management, driver and passenger archive management, and driver behavior evaluation.

For example, through the driver identity verification management, the driver identity information and the identity verification result may be received, and the received driver and passenger identity information may be verified and compared and analyzed with the affiliated enterprise driver and passenger archive information and electronic waybill scheduling information. When the driver identity verification succeeds and the received driver and passenger identity information is consistent with the affiliated enterprise driver and passenger archive information and the electronic waybill scheduling information, a driving-permitted command is sent, so that the vehicle may start and travel normally. When the driver identity verification fails or the received driver and passenger identity information is inconsistent with the affiliated enterprise driver and passenger archive information and the electronic waybill scheduling information, a driving-prohibited command is sent, so that the vehicle cannot start and travel normally, and warning information is sent to the driver and passenger service client in the form of a text, an image, a voice, a file, or the like. If the vehicle starts and travels abnormally when the driver identity verification fails or the received driver and passenger identity information is inconsistent with the affiliated enterprise driver and passenger archive information and the electronic waybill scheduling information, an emergency alarm prompt is displayed and a corresponding unit of the on-board device is controlled to send acousto-optic alarm information inside and outside the vehicle. Through the driver identity verification management, the carrier management client supports remote driver permission authorization and remote emergency enable of a vehicle ACC switch, and supports recording, analysis, and querying of received driver and passenger identity verification results, driver and passenger identity information, and results of comparison between and analysis of the driver and passenger identity information and affiliated enterprise driver and passenger archive information or electronic waybill scheduling information.

Through the abnormal driver behavior and fatigue state monitoring and alarm, monitoring and alarm information of an abnormal sentiment, an abnormal behavior, and a fatigue state of the driver may be received and displayed. When an alarm is received, warning information is sent to the driver and passenger service client in the form of a text, an image, a voice, a file, or the like. When a high-risk alarm is received, warning information is sent to the driver and passenger service client in the form of a text, an image, a voice, a file, or the like, and linkage management information is immediately synchronously sent to the government industry management client according to the set emergency plan.

Through the driver overtime driving alarm management, driver overtime driving alarm information may be received and displayed. When an alarm is received, warning information is sent to the driver and passenger service client in the form of a text, an image, a voice, a file, or the like. When a high-risk alarm is received, warning information is sent to the driver and passenger service client in the form of a text, an image, a voice, a file, or the like, and linkage management information is immediately synchronously sent to the government industry management client according to the set emergency plan.

Through the driver and passenger archive management, archives of the driver and the passenger such as the driver or the escort of the hazardous chemicals transportation vehicle, and other passengers may be managed. Content of the archive management includes information such as a name, a gender, an identity number, a qualification certificate number, a validity of the qualification certificate, a personnel category, a personnel registered residence address, an actual residential address, family members, main social relations, and the like. The driver and passenger archive management supports querying, addition, deletion, and modification and editing of the archive content of the driver and passenger. During addition, deletion, and editing of the archive information content of the driver and passenger, prompt information is sent to the driver and passenger service client, and the addition, deletion, or editing becomes effective after a corresponding person whose information was subjected to the addition or deletion or whose archive information was modified or edited logs in and confirms the addition, deletion, or editing. The driver and the passenger may submit an addition, deletion, modification, or edition application through the driver and passenger service client, confirm an archiving manner through the carrier management client, and subject the driver and passenger archive information to the addition, deletion, modification, or editing.

The driver behavior evaluation supports driver behavior evaluation based on relevant information such as different alarm types, alarm numbers, alarm levels, alarm processing statuses, and the like. For different alarm types, alarm numbers, alarm levels, alarm processing response times, and alarm processing rates, different weights are assigned, and the weights may be set and adjusted. Driver behavior evaluation results may be quantified, results of the quantification may be ranked, and corresponding report forms may be generated. Querying may be performed based on ranks of the quantified evaluation results, vehicle type information, license plate number information, or driver information.

The receiver management client software 123 in the enterprise operation management client 120 in this embodiment is configured to receive and display safety tracking and querying information of a goods consignment vehicle (the vehicle carrying hazardous goods). In addition, the receiver management client software 123 is further configured for driver identity information querying. For example, the receiver management client software 123 supports querying of identity information, a qualification certificate, and a current transportation identity verification result of a current transportation driver or an escort of the hazardous goods transportation vehicle corresponding to an electronic waybill number.

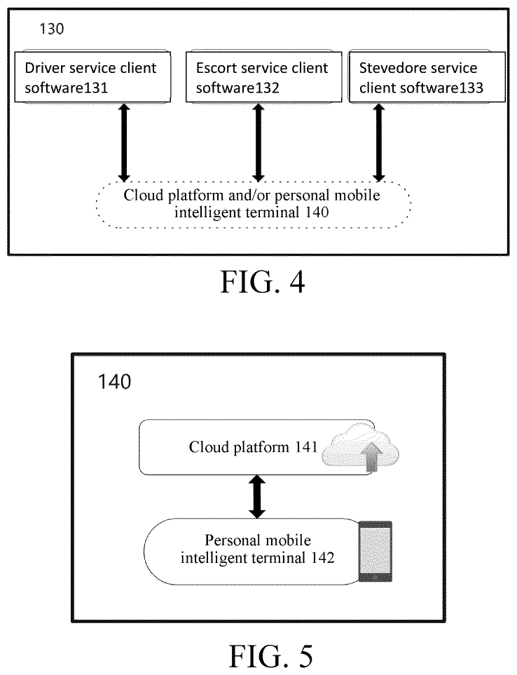

FIG. 4 is a schematic diagram of a composition principle of the driver and passenger service client unit 130 in the safety monitoring client for vehicle transportation of hazardous goods 100 according to an embodiment.

As shown in FIG. 4, the driver and passenger service client unit 130 provided in this embodiment includes a driver service client software 131, an escort service client software 132, and a stevedore service client software 133 depending on different users.

As shown in FIG. 1 and FIG. 4, the driver service client software 131 in the driver and passenger service management client 130 in this embodiment is configured to: receive the safety monitoring information of the on-board hazardous goods sent by the on-board terminal 200 of the hazardous goods transportation vehicle for the hazardous goods forwarded by the communication center 140, such as the physical and chemical safety monitoring and warning information of the on-board hazardous goods or the anti-theft and anti-robbery monitoring and warning information of the on-board hazardous goods, receive and display emergency rescue guide information sent by the carrier management client 122 in the form of a text, an image, a voice, a file, or the like, or display emergency rescue guide information automatically pushed after relevant warning alarm information is triggered by the driver service client software.

The driver service client software 131 is further configured to: receive and display the vehicle safety monitoring information sent by the on-board terminal 200 of the hazardous goods transportation vehicle for the vehicle carrying hazardous goods forwarded by the communication center 140, such as the real-time monitoring and warning information of tire pressure, the vehicle overheat monitoring and warning information, and the warning information of new energy vehicle lithium-ion power battery explosion, and receive and display emergency rescue guide information sent by the carrier management client 122 in the form of a text, an image, a voice, a file, or the like.

The driver service client software 131 is further configured for driver identity verification, abnormal driver behavior and fatigue state monitoring and alarm, and driver overtime driving alarm.

For example, through the driver identity verification, the driver identity information, the biometric information, and the identity verification result may be received. When the driver identity verification succeeds and the information is consistent with the affiliated enterprise driver and passenger archive information and the electronic waybill scheduling information, a driving-permitted command from the carrier management client is received and broadcast through voice, and the driver is prompted to normally start and drive the vehicle. When the identity verification fails or the information is inconsistent with the affiliated enterprise driver and passenger archive information and the electronic waybill scheduling information, a driving-prohibited command from the carrier management client is received and broadcast through voice, and the driver prompted through voice to adjust an attitude perform certificate verification.

Through the abnormal driver behavior and fatigue state monitoring and alarm, abnormal driver behavior and fatigue state monitoring and alarm information may be received and displayed. When a medium-risk-level or a low-risk level alarm is received, warning information is sent through a voice or a specific preset sound. When a high-risk alarm delivered by the government industry management client and the carrier management client is received, warning information is sent through a voice set for high-level alarm content or a preset sound for a specific high-level alarm, and a correction status and a correction measure may be fed back within a specified time in the form of a text, an image, a voice, a file, or the like.

Through the driver overtime driving alarm, the driver overtime driving alarm information may be received and displayed. When an overtime driving alarm delivered by the government industry management client and the carrier management client is received, warning information is broadcast through voice, and a correction status of an overtime driving violation is automatically fed back to the government industry management client and the carrier management client after the overtime driving violation of the vehicle is corrected.

It should be noted that the driver service client software 131 supports voice broadcast of the warning information. For a commercial vehicle, a risk detection status and a handling result may be fed back to the government industry management client 110 and the carrier management client 122 after the driver completes a risk detection.

The escort service client software 132 in the driver and passenger service management client 130 in this embodiment is configured to: receive the safety monitoring information of the on-board hazardous goods sent by the on-board terminal 200 of the hazardous goods transportation vehicle for the hazardous goods forwarded by the communication center 140, such as the physical and chemical safety monitoring and warning information of the on-board hazardous goods or the anti-theft and anti-robbery monitoring and warning information of the on-board hazardous goods, receive and display emergency rescue guide information sent by the carrier management client software 122 in the form of a text, an image, a voice, a file, or the like, or display emergency rescue guide information automatically pushed after relevant warning alarm information is triggered by the driver service client software.

The escort service client software 132 is further configured to: receive and display the vehicle safety monitoring information sent by the on-board terminal 200 of the hazardous goods transportation vehicle for the vehicle carrying hazardous goods forwarded by the communication center 140, such as the real-time monitoring and warning information of tire pressure, the vehicle overheat monitoring and warning information, and the warning information of new energy vehicle lithium-ion power battery explosion, and receive and display emergency rescue guide information sent by the carrier management client 122 in the form of a text, an image, a voice, a file, or the like.

The escort service client software 132 is further configured for abnormal driver behavior and fatigue state monitoring and alarm and driver overtime driving alarm.

For example, through the abnormal driver behavior and fatigue state monitoring and alarm, abnormal driver behavior and fatigue state monitoring and alarm information may be received and displayed. When a medium-risk-level or low-risk-level alarm is received, warning information is sent through a voice or a specific preset sound. When a high-risk alarm delivered by the government industry management client and the carrier management client is received, warning information is sent through a voice set for high level alarm content or a preset sound for a specific high level alarm, the escort is continuously prompted through a voice to supervise the driver in correcting the abnormal behavior or stopping and resting when appropriate, and a correction status and a correction measure may be fed back within a specified time in the form of a text, an image, a voice, a file, or the like.

Through the driver overtime driving alarm, the driver overtime driving alarm information may be received and displayed. When an overtime driving alarm issued by the government industry management client and the carrier management client is received, warning information is broadcast through a voice or a preset sound, the escort is continuously prompted through a voice to supervise the driver in stopping and resting when appropriate and a correction status of an overtime driving violation is automatically fed back to the government industry management client and the carrier management client after the overtime driving violation of the vehicle is corrected.

The escort service client software 132 supports voice broadcast of the warning information, and supports feedback of a risk detection status and a handling result to the government industry management client 110 and the carrier management client 122 by the escort after the driver completes a risk detection.

The stevedore service client software 133 in the driver and passenger service unit 130 is configured to receive and display an electronic waybill for road transportation of the hazardous goods, and a quantity change and inventory information during loading/unloading of the hazardous goods uploaded by the on-board terminal 200 of the hazardous goods transportation vehicle, and supports querying of a type, a quantity, a loading/unloading requirement, a physical characteristic, a chemical characteristic, a physical and chemical hazard, and corresponding emergency rescue guide information of the hazardous goods currently being transported.

FIG. 5 is a schematic diagram of a composition principle of the communication center 140 in the safety monitoring client 100 for vehicle transportation of hazardous goods according to an embodiment.

As shown in FIG. 5, the communication center 140 provided in this embodiment includes a cloud platform 141 and/or a personal mobile intelligent terminal 142. The embodiment preferably adopts an application manner of combining the cloud platform 141 and the personal mobile intelligent terminal 142 for the communication center, which may be determined based on actual communication conditions of different users, and is not limited herein.

As shown in FIG. 1 and FIG. 5, the cloud platform 141 in the communication center 140 is configured for storage of data information and alarm information uploaded by an on-board gateway unit 400, receipt of data of the government industry management client unit 110/the enterprise operation management client unit 120/the driver and passenger service client unit 130, and communication interaction among a called shared data resource pool, a computer hardware platform environment supporting application of the government industry management client unit 110/the enterprise operation management client unit 120/the driver and passenger service client unit 130, the government industry management client unit 110/the enterprise operation management client unit 120/the driver and passenger service client unit 130, and the on-board terminal 200 of the hazardous goods transportation vehicle.

The cloud platform 141 may communicate with the on-board terminal 200 of the hazardous goods transportation vehicle, receive and store the safety monitoring information of the on-board hazardous goods sent by the on-board terminal 200 of the hazardous goods transportation vehicle, such as the physical and chemical safety monitoring and warning information of the on-board hazardous goods or the anti-theft and anti-robbery monitoring and warning information of the on-board hazardous goods, and forward a management command or a response command of the government industry management client unit 110, the enterprise operation management client unit 120, and the driver and passenger service client unit 130 to the on-board terminal 200 of the hazardous goods transportation vehicle.

The cloud platform 141 further receives and stores the vehicle safety monitoring information sent by the on-board terminal 200 of the hazardous goods transportation vehicle, such as the real-time monitoring and warning information of tire pressure, the vehicle overheat monitoring and warning information, the warning information of new energy vehicle lithium-ion power battery explosion, and relevant monitoring data and information, and forwards a management command or a response command of the government industry management client unit 110, the enterprise operation management client unit 120, and the driver and passenger service client unit 130 to the on-board terminal 200 of the hazardous goods transportation vehicle.

The cloud platform 141 further receives and stores the driver identity document acquisition result, the driver biometric information acquisition result, or the identity verification result sent by the on-board terminal 200 of the hazardous goods transportation vehicle, and receives and stores current dynamic facial expression information of the driver, current head, face, and body movement attitude information of the driver, current head and face movement information of the driver, and pressure status information of a seat under the driver or the driver state monitoring result acquired by the on-board terminal 200 of the hazardous goods transportation vehicle. When a biometric information comparison component, an intelligent sentiment analysis and identification component, an abnormal behavior analysis and identification component, a video analysis-based fatigue state analysis component, or a sensor network analysis-based fatigue state analysis component is arranged on the cloud platform 141, through the cloud platform 141, biometric information comparison, intelligent sentiment analysis and identification, abnormal behavior analysis and identification, or fatigue state analysis and determination may be performed, and a management command or a response command of the government industry management client unit 110, the enterprise operation management client unit 120, and the driver and passenger service client unit 130 may be forwarded to the on-board terminal 200 of the hazardous goods transportation vehicle.

For example, the cloud platform 141 supports application to a B/S monitoring client, and the B/S monitoring client is preferably developed based on the latest version high-security operating system and a high-security browser (Xin Chuang version).

The personal mobile intelligent terminal 142 in the communication center 140 in this embodiment is configured for storage of data information and alarm information uploaded by the on-board terminal 200 of the hazardous goods transportation vehicle and communication interaction among an online querying tool and a temporary storage space of the uploaded data information for the government industry management client APP software 110/the enterprise operation management client APP software 120/the driver and passenger service client APP software 130, a microcomputer hardware platform environment supporting application of the government industry management client APP software 110/the enterprise operation management client APP software 120/the driver and passenger service client APP software 130, the government industry management client APP software 110/the enterprise operation management client APP software 120/the driver and passenger service client APP software 130, and the on-board gateway unit 400.

In addition, the personal mobile intelligent terminal 142 may further communicate with the on-board terminal 200 of the hazardous goods transportation vehicle through the cloud platform 141, receive and store the safety monitoring information of the on-board hazardous goods sent by the on-board terminal 200 of the hazardous goods transportation vehicle for the hazardous goods, such as the physical and chemical safety monitoring and warning information of the on-board hazardous goods or the anti-theft and anti-robbery monitoring and warning information of the on-board hazardous goods, and forward a management command or a response command or emergency rescue guide information of the government industry management client mobile APP software 110/the enterprise operation management mobile client APP software 120/the driver and passenger service mobile client APP software 130 to the on-board gateway unit 400.

The personal mobile intelligent terminal 142 further receives and stores the vehicle safety monitoring information sent by the on-board terminal 200 of the hazardous goods transportation vehicle for the vehicle carrying hazardous goods, such as the real-time monitoring and warning information of tire pressure, the vehicle overheat monitoring and warning information, the warning information of new energy vehicle lithium-ion power battery explosion, and relevant monitoring data and information, and forwards a management command or a response command of the government industry management client mobile APP software 110/the enterprise operation management mobile client APP software 120/the driver and passenger service mobile client APP software 130 to the on-board gateway unit 400.

The personal mobile intelligent terminal 142 further receives the driver identity document acquisition result, the driver biometric information acquisition result, or the identity verification result sent by the on-board terminal 200 of the hazardous goods transportation vehicle for the driver of vehicle carrying hazardous goods, and receives the driver state monitoring and alarm information sent by the on-board terminal 200 of the hazardous goods transportation vehicle for the driver of vehicle carrying hazardous goods, and forwards a management command or a response command of the government industry management mobile client APP software 110/the enterprise operation management client mobile APP software 120/the driver and passenger service mobile client APP software 130 to the on-board terminal 200 of the hazardous goods transportation vehicle.

For example, the mobile monitoring client APP is preferably developed based on a Linux kernel-based operating system such as HarmonyOS microkernel or Android.

The safety monitoring client for vehicle transportation of hazardous goods formed in such way is preferably arranged on a cloud platform of a vehicle traffic management or operation management-related government industry administration department and/or a personal mobile intelligent terminal of a relevant management person, a cloud platform of a transportation enterprise to which a vehicle belongs and a related transportation party and/or a personal mobile intelligent terminal of a relevant management person, and a personal mobile intelligent terminal of a driver and a passenger, and is associated with the on-board terminal 200 of the hazardous goods transportation vehicle.

The safety monitoring client for vehicle transportation of hazardous goods deployed in such way receives the real-time monitoring information and warning alarm information of the hazardous goods, the vehicle carrying hazardous goods, and the driver of the vehicle carrying hazardous goods sent by the 200 on-board terminal of the hazardous goods transportation vehicle, and provides a management and operation command to the on-board terminal 200 of the hazardous goods transportation vehicle based on the alarm information. In this way, real-time monitoring information of the goods, the vehicle, and the person during the transportation of the on-board hazardous goods may be linked to the industry administration department and the affiliated enterprise, which not only helps the driver and passenger in on-site handling and prevents accidents, but also wins time for early deployment of emergency rescue and response forces, anti-terrorism prevention forces, and rapid launch of emergency rescue and anti-terrorism investigation work, thereby improving monitoring, warning, and prevention abilities of hazardous goods transportation safety accidents, enhancing efficiency of emergency response to hazardous goods transportation safety accidents, and enhancing the anti-terrorism prevention ability for hazardous goods transportation.

The foregoing method, or a specific system unit, or a part of the unit of the present invention is a pure software architecture, which may be arranged in physical media such as a hard disk, a compact disc, or any electronic device (such as a smart phone or a computer-readable storage medium) through program code. When a machine loads and executes the program code (for example, the smart phone loads and executes the program code), the machine becomes a device for implementing the present invention. The foregoing method and device of the present invention may be further transmitted through some transmission media, such as a cable, an optical fiber, or any other transmission form in the form of program code. When the program code is received, loaded, and executed by the machine (for example, a smart phone), the machine becomes the device for implementing the present invention.

The basic principles, main features, and advantages of the present invention are shown and described above. A person skilled in the art should understand that the present invention is not limited by the foregoing embodiments. The foregoing embodiments and the description in the specification only illustrate the principles of the present invention, and there will be various changes and improvements in the present invention without departing from the spirit and scope of the present invention. These changes and improvements fall within the protection scope of the present invention. The protection scope of the present invention is defined by the appended claims and equivalents.

What is claimed is:

1. A cloud platform-based safety monitoring client for vehicle transportation of hazardous goods, deployed in a manner supporting synchronous multi-level linkage of a plurality of user roles and configured to: receive real-time information of a vehicle, a driver, and on-board goods sent by an on-board terminal of a hazardous goods transportation vehicle, and perform synchronous multi-industry, multi-user role, and multi-level linkage display on the received information and perform multi-level linkage processing based on the received information, to form corresponding feedback information for the on-board terminal of the hazardous goods transportation vehicle.

2. The safety monitoring client for vehicle transportation of hazardous goods according to claim 1, comprising:
a government industry management client unit, an enterprise operation management client unit, a driver and passenger service client unit, and a communication center, wherein
the government industry management client unit is configured to: receive and display real-time monitoring information and/or danger warning alarm information for hazardous goods and/or a vehicle carrying hazardous goods and/or a vehicle driver sent by the on-board terminal of the hazardous goods transportation vehicle, send a relevant management command based on the received warning alarm information, start an emergency management process, and issue a relevant emergency response command;
the enterprise operation management client unit is configured to: receive and display the real-time monitoring information and/or the danger warning alarm information for the hazardous goods and/or the vehicle carrying hazardous goods and/or the vehicle driver sent by the on-board terminal of the hazardous goods transportation vehicle, send a relevant management command based on the received warning alarm information, start an emergency management process, and issue a relevant emergency response command; and start the emergency management process, issue the relevant emergency response command, and issue an emergency alarm and the relevant emergency response command to the government industry management client unit when receiving high-risk-level danger warning alarm information;
the driver and passenger service client unit is configured to: receive and display the real-time monitoring information and/or the danger warning alarm information for the hazardous goods and/or the vehicle carrying hazardous goods and/or the vehicle driver sent by the on-board terminal of the hazardous goods transportation vehicle, and generate a corresponding alarm prompt and/or emergency response guidelines corresponding to the warning alarm information based on the received danger warning alarm information; and
the communication center is configured to: store the real-time monitoring information and/or the danger warning alarm information for the hazardous goods and/or the vehicle carrying hazardous goods and/or the vehicle driver sent by the on-board terminal of the hazardous goods transportation vehicle, and/or perform intelligent identification and analysis based on the received information, and forward the received information and/or an analysis result to the government industry management client unit, the enterprise operation management client unit, and the driver and passenger service client unit, wherein the communication center is further configured as a computer system environment for the government industry management client unit, the enterprise operation management client unit, and the driver and passenger service client unit, supports a relevant software application, and forwards a management command or a response command of the government industry management client unit, the enterprise operation management client unit, and the driver and passenger service client unit to the on-board terminal of the hazardous goods transportation vehicle.

3. The safety monitoring client for vehicle transportation of hazardous goods according to claim 2, wherein the government industry management client unit comprises a public security industry management client software, a traffic industry management client software, an emergency industry management client software, and another industry management client software depending on different industry administration departments;
the public security industry management client software is configured to: receive the real-time monitoring information and/or the danger warning alarm information for the hazardous goods and/or the vehicle carrying hazardous goods and/or the vehicle driver sent by the on-board terminal of the hazardous goods transportation vehicle forwarded by the communication center, send a traffic management command to a traffic policeman on duty at a position of the vehicle and send a traffic accident handling command for the corresponding vehicle and position to a relevant traffic accident handling person based on a type of the information, and send emergency rescue linkage management information according to a set emergency plan; and send warning information to the enterprise operation management client unit and the driver and passenger service client unit, and send linkage management information according to the set emergency plan;
the traffic industry management client software is configured to: receive the real-time monitoring information and/or the danger warning alarm information for the hazardous goods and/or the vehicle carrying hazardous goods and/or the vehicle driver sent by the on-board terminal of the hazardous goods transportation vehicle forwarded by the communication center, send a management command to a relevant traffic safety accountability enterprise based on the type of the information, and send other linkage management information according to the set emergency plans; and send warning information to the enterprise operation management client unit and the driver and passenger service client unit, and send linkage management information according to the set emergency plan;
the emergency industry management client software is configured to: receive and display the real-time monitoring information and/or the danger warning alarm information for the hazardous goods and/or the vehicle carrying hazardous goods and/or the vehicle driver sent by the on-board terminal of the hazardous goods transportation vehicle forwarded by the communication center, send an emergency response command to a relevant emergency rescue person based on the type of the information, a type of the vehicle, a type of the goods loaded on the vehicle, and behavior state information of the driver, and send other linkage management information according to the set emergency plan; and
the another industry management client software is configured to: receive and display the real-time monitoring information and/or the danger warning alarm information for the hazardous goods and/or the vehicle carrying hazardous goods and/or the vehicle driver sent by the on-board terminal of the hazardous goods transportation vehicle forwarded by the communication center, start an insurance claims service based on a state of the information, and send other linkage management information according to the set emergency plan.

4. The safety monitoring client for vehicle transportation of hazardous goods according to claim 3, wherein the public security industry management client software is configured for driver identity verification management, driver identity management, abnormal driver behavior and fatigue state monitoring and alarm, vehicle safety monitoring and alarm, and on-board hazardous goods safety monitoring and alarm;
the traffic industry management client software is configured for driver identity verification management, driver permission supervision, abnormal driver behavior and fatigue state monitoring and alarm, driver and passenger archive management, driver behavior evaluation, vehicle safety monitoring and alarm, and on-board hazardous goods safety monitoring and alarm; and
the emergency industry management client software is further configured for driver identity verification management, abnormal driver behavior and fatigue state monitoring and alarm, vehicle safety monitoring and alarm, and on-board hazardous goods safety monitoring and alarm.

5. The safety monitoring client for vehicle transportation of hazardous goods according to claim 2, wherein the enterprise operation management client unit comprises a consigner management client software, a carrier management client software, and a receiver management client software depending on different users;
the consigner management client software is configured to receive and display the safety tracking and querying information of the goods consignment vehicle, query the electronic waybill of the hazardous goods, and query the driver identity information;
the carrier management client software is configured to: receive and display the real-time monitoring information and/or the danger warning alarm information for the hazardous goods and/or the vehicle carrying hazardous goods and/or the vehicle driver sent by the on-board terminal of the hazardous goods transportation vehicle forwarded by the communication center; send emergency rescue guide information and/or warning information to the driver and passenger service client unit when receiving the warning alarm information; and send the emergency rescue guide information and/or warning information to the driver and passenger service client unit, and immediately synchronously send linkage alarm information to the government industry management client unit according to the set emergency plan when receiving a high-risk-level warning alarm; and
the receiver management client software is configured to receive and display the safety tracking and querying information of the goods consignment vehicle, query the electronic waybill of the hazardous goods, and query the driver identity information;

6. The safety monitoring client for vehicle transportation of hazardous goods according to claim 5, wherein the carrier management client software is configured for driver identity verification management, abnormal driver behavior and fatigue state monitoring, driver overtime driving alarm management, driver and passenger archive management, driver behavior evaluation, vehicle safety monitoring and alarm, and on-board hazardous goods safety monitoring and alarm, wherein the driver identity verification management of the carrier management client software supports remote driver permission authorization and remote emergency enable of a vehicle ACC switch, and supports recording, analysis, and querying of received driver and passenger identity verification results, driver and passenger identity information, and results of comparison between and analysis of the driver and passenger identity information and affiliated enterprise driver and passenger archive information or electronic waybill scheduling information.

7. The safety monitoring client for vehicle transportation of hazardous goods according to claim 2, wherein the driver and passenger service management client unit comprises a driver service client software, an escort service client software, and a stevedore service client software depending on different users;
the driver service client software is configured to: receive and display the real-time monitoring information and/or the danger warning alarm information for the hazardous goods and/or the vehicle carrying hazardous goods and/or the vehicle driver sent by the on-board terminal of the hazardous goods transportation vehicle forwarded by the communication center, and receive and display emergency rescue guide information sent by the enterprise operation management client unit or display emergency rescue guide information or a driving-permitted command automatically pushed after relevant warning alarm information is triggered; and support feedback of a risk detection status and a handling result to the government industry management client unit and the enterprise operation management client unit after the driver completes a risk detection;
the escort service client software is configured to: receive and display the real-time monitoring information and/or the danger warning alarm information for the hazardous goods and/or the vehicle carrying hazardous goods and/or the vehicle driver sent by the on-board terminal of the hazardous goods transportation vehicle forwarded by the communication center; receive and display emergency rescue guide information sent by the enterprise operation management client unit or display emergency rescue guide information or a driving-permitted command automatically pushed after relevant warning alarm information is triggered; and generate corresponding warning information after receiving a risk alarm sent by the government industry management client unit and the enterprise operation management client unit; and supports an escort to feed back a risk detection status and a handling result to the government industry management client and the carrier management client after the driver completes a risk detection; and
the stevedore service client software is configured to receive and display an electronic waybill of road transportation of the hazardous goods, and a quantity change and inventory information of the hazardous goods during loading/unloading, and supports querying of a type, a quantity, a loading/unloading requirement, a physical characteristic, a chemical characteristic, a physical and chemical hazard, and corresponding emergency rescue guide information of the hazardous goods currently being transported.

8. The safety monitoring client for vehicle transportation of hazardous goods according to claim 7, wherein the driver service client software is configured for driver identity verification management, abnormal driver behavior and fatigue state monitoring, driver overtime driving alarm management, vehicle safety monitoring and alarm, and on-board hazardous goods safety monitoring and alarm; and the escort service client software is configured for driver identity verification management, escort identity verification management, abnormal driver behavior and fatigue state monitoring, driver overtime driving alarm management, vehicle safety monitoring and alarm, and on-board hazardous goods safety monitoring and alarm.

9. The safety monitoring client for vehicle transportation of hazardous goods according to claim 2, wherein the communication center comprises a cloud platform and a personal mobile intelligent terminal;
the cloud platform is configured for storage of data information and alarm information uploaded by the on-board terminal of the hazardous goods transportation vehicle, receipt of data of the government industry management client software/the enterprise operation management client software/the driver and passenger service client software, and communication interaction among a called shared data resource pool, a computer hardware platform environment supporting application of the government industry management client software/the enterprise operation management client software/the driver and passenger service client software, the government industry management client software/the enterprise operation management client software/the driver and passenger service client software, and an on-board gateway unit; and
the personal mobile intelligent terminal is configured for storage of data information and alarm information uploaded by the on-board terminal of the hazardous goods transportation vehicle and communication interaction among an online querying tool and a temporary storage space of the uploaded data information for the government industry management client APP software/the enterprise operation management client APP software/the driver and passenger service client APP software, a microcomputer hardware platform environment supporting application of the government industry management client APP software/the enterprise operation management client APP software/the driver and passenger service client APP software, the government industry management client APP software/the enterprise operation management client APP software/the driver and passenger service client APP software, and the on-board gateway unit.
